(19) United States
(12) Patent Application Publication
(10) Pub. No.: US 2015/0296101 A1
(43) Pub. Date: Oct. 15, 2015

(54) Universal Film mode detection for interlaced video stream

(71) Applicant: Tao Han, Markham (CA)

(72) Inventor: Tao Han, Markham (CA)

(73) Assignee: Tao Han, Markham (CA)

(21) Appl. No.: 14/248,442

(22) Filed: Apr. 9, 2014

(51) Int. Cl. H04N 5/04; H04N 7/00

(52) U.S. Cl. CPC H04N 5/04; H04N 7/00

(57) ABSTRACT

A universal film mode detection method is presented here which is capable to detect different cadences like 3:2, 2:2, 32322, 4:4 and etc. The film mode detection is based on searching for moving “Sandwich” patterns in the merged adjacent fields. The number of “Sandwich” patterns and amplitude of “Sandwich” patterns are accumulated across the whole field which will be used to determine the film mode. A vertical symmetric “Sandwich” pattern detector is used to avoid different result in ODD and EVEN fields. This improved film mode detection method can provide reliable result for deinterlacer which is used to improve the vertical resolution in interlaced video during converting to progressive. The same structure with different threshold can also provide information for temporal interpolator which can be used to remove judder effect by increasing the frame rate.

### CROSS-REFERENCES TO RELATED APPLICATIONS

N/A

### FIELD OF THE INVENTION

The present invention relates to video signal processing which may be used in television, media player or set top box. More particularly, the present invention relates to improved multi cadence film mode detection and the result can be used for spatial interpolation (deinterlace) or temporal interpolation (increase frame rate).

### DESCRIPTION OF RELATED ART

In accordance with U.S. Pat. No. 4,876,976, it is known to detect that a 60 Hz NTSC television signal has as its source a 24 frame/second motion picture film. U.S. Pat. No. 4,982,280 discloses an arrangement for detecting a 30 Hz progressive scan source, which may be a video camera or film, in a 60 Hz progressively scanned non-interlaced television system. Published International Patent Application WO 94/30006 discloses apparatus for detecting 25 frame/second motion picture film sources in 50 Hz television signals. U.S. Pat. No. 6,859,237 incorporates an improved field motion detector, a frame motion detector.

### BACKGROUND

A film source is consisted of a serial of frames with the frame rate A(A<60). For typical movie, A is 24 frame/second or 25 frame/second. But the frame rate A is not limited to these 2 numbers, for example, it is common to find 30 frame/second source in some computer generated videos or 12 frame/second, even 8 frame/second in some cartoons.

When film source is converted to video streams which is typically in 60 Hz or 50 Hz, frame duplicate will happen. For example, the 24 frame to 60 hz NTSC video conversion use the so called 3:2 pull down mode:

AABBBCCDDDEE where A, B, C, D, E are successive film frames.

Here is the list of most common cadence. The “adjacent field difference” means the accumulated difference on same position between two fields. When these two fields are from the same frame, their difference is low and denoted as “0”; otherwise their difference is high and denoted as ‘1”.

| Pattern name | Source | Adjacent field difference |
|---|---|---|
| 2:2 | 30 Hz film NTSC/25 | 10 |
| | Hz film PAL | |
| 3:2 | 24 Hz film NTSC | 00101 |
| 4:4 | Japanese anime | 1000 |
| 2:2:2:4 | DVCAM | 1010101000 |
| 2:3:3:2 | DVCAM | 1010010010 |
| 5:5 | Japanese anime | 1000010000 |
| 6:4 | Japanese anime | 1000001000 |
| 3:2:3:2:2 | Vari-speed broadcast | 100101001010 |
| 8:7 | Japanese anime | 100000001000000 |
| 1:2:2:2:2 | Varispeed pulldown | 110101010 |
| | (25 fps + 10%) | |
| 3:2:2:2:2 | Varispeed pulldown | 10010101010 |
| | (24 fps + 14.6%) | |
| 322222222222 | Telecine B | 1001010101010101010101010 |

In interlaced video, the adjacent fields are sampled at different position even they are from the same frame. For example, first field is from ODD lines and the second field is from EVEN lines. So directly subtract these two fields will not get the difference. Here the spatial difference between ODD and EVEN lines is mixed with the temporal motion. To find out if two adjacent fields are from the same frame is the key for film mode detection. The so called “sandwich pattern detection” method will be mentioned later in this patent.

After the “adjacent field difference” is detected, based on this high-low sequence, a film mode arbiter will determine which cadence it is. In real video, film sources may be overlapped with video contents (for example, the overlapped caption). Such video streams are called “mixed mode”. Film sources may also be edited which will generate glitches in the video. All these issues will make film cadence detection more difficult.

After a film cadence is correctly detected, such information can be used in deinterlacer which can simply merge two fields from the same frame back to the original frame.

If two fields from different frames are merged together, an artefact called “feathering” may appear if there is motion between these two fields.

The film cadence information detected can also be used as the input for temporal interpolation. For example, for a 60 hz video input and 120 hz output, we have these methods:
If input is video, each field generate two output frames. 60×2=120
If input is 3:2 film, there are 24 frames in input and each frame generates 5 output frames. 24×5=120
If input is 2:2 film, there are 30 frames in input and each frame generates 4 output frames. 30×4=120

Temporal interpolation can generate more smooth output video if the correct film cadence can be detected. Otherwise, we may see discontinuity in the output which is called “judder” effect.

These days, edited video streams are getting more are more popular so various cadence detection become a challenge both for deinterlacer and temporal interpolation.

This universal film mode detection method can achieve the good performance respectively for both deinterlacer and MCTI (Motion Compensated Temporal Interpolation) based on different requirement in these two blocks. Deinterlacer usually requires feathering free and MCTI requires less judder.

This universal film mode detection method can well tolerate video+film mixed mode and bad edit in the interlaced video stream.

### BRIEF DESCRIPTION OF THE DRAWINGS

FIG. 1 is the block diagram of film mode detection.

FIG. 2 is the detail of Sandwich pattern accumulator.

FIG. 3 is pixels used in Sandwich pattern detection.

FIG. 4 is example of a moving diagonal bar.

FIG. 5 is Sandwich pattern detected area by the Sandwich pattern accumulator.

FIG. 6 is the Sandwich pattern area for different movement direction.

FIG. 7 is the Sandwich pattern accumulated amplitude waveform.

FIG. 8 is the flow chart for film mode detection.

### DETAILED DESCRIPTION OF THE PREFERRED EMBODIMENTS

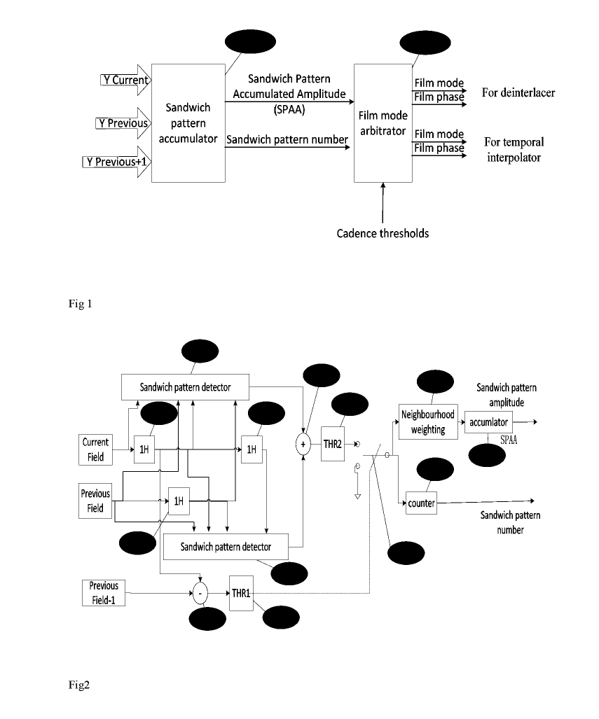

FIG. 1 is the block diagram of film mode detection. The design contains two parts:

101: Sandwich pattern accumulator. It detects Sandwich pattern in most recent 3 fields pixel by pixel and generate the sandwich pattern accumulated amplitude (SPAA) and Sandwich pattern number of a field. Considering the speed requirement for real time video steam, this part is usually implemented by hardware.

102: Film mode arbitrator. This part determines if we need to enter or quit a film mode by analyzing the accumulated SPAA and sandwich pattern number. This analysis only requires once per field so it is usually implemented by software (firmware).

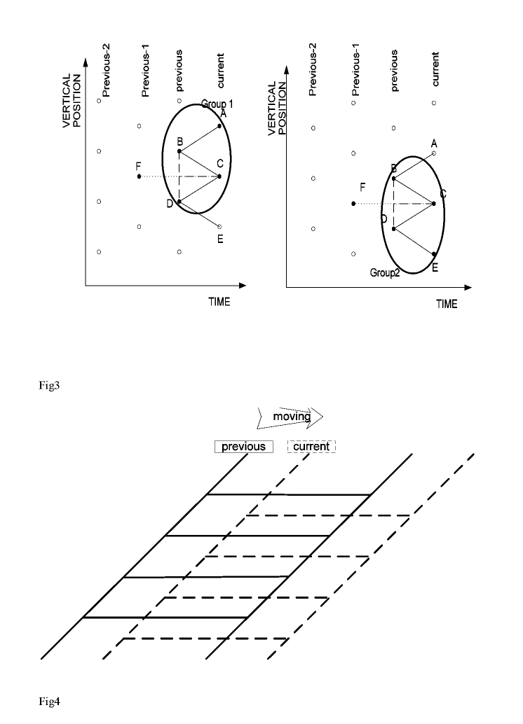

FIG. 2 is the detail of Sandwich pattern accumulator. Sandwich pattern is detected in the meshed progressive frame by current field and previous field. In vertical direction, if the luminance level of a pixel is higher than both adjacent pixels, we denote it as “1”. If it is lower than both adjacent pixels, we denote it as “0”. A Sandwich pattern may contains these two cases:
x01x or
x10x
   where “x” mean don't care.

If we denote the 4 pixels from top to bottom as P1, P2, P3 and P4, then in these two cases we call it a Sandwich pattern:
Case1: P2<P1 AND P2<P3 AND P3>P4, This is the x01x case.
   or
Case2: P2>P1 AND P2>P3 AND P3<P4, This is the x10x case.

Visually, the Sandwich pattern is the minimum size of a “feathering” pattern we can see in the meshed progressive frame.

Where a Sandwich pattern is detected, the amplitude of such a Sandwich pattern is denoted as:

Sandwich pattern amplitude=Min(|p2−p1|,|p3−p2|,|p4−p3|).

i.e. the amplitude equals to the minimum of absolute difference between these pixels.

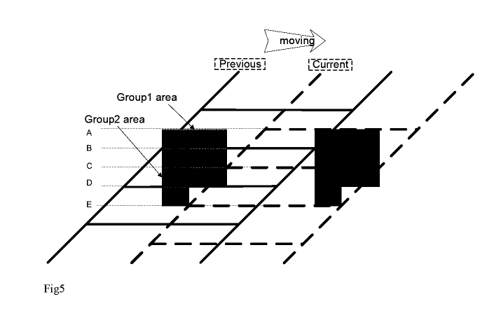

In FIG. 2, 201 and 202 are two Sandwich pattern detectors with the same structure. 203, 204 and 205 are 1 line delay. Each of the Sandwich pattern detectors has 4 pixels input. The delay in 203, 204 and 205 will generate two groups of 4 pixels as shown in FIG. 3 for each Sandwich pattern detector. 201 will use pixel ABCD which is group 1 in FIG. 3 and 202 will use pixel BCDE which is group 2 in FIG. 3.

The output from 201 and 202 will be summed up in 211. This sum will be compared with a threshold: THR2 in 207. If the sum is bigger than THR2, then we will output the sum, otherwise, we output 0.

Current pixel will be compared with the pixel at same location in previous-1 field (212) to generate frame motion value. Once the difference is smaller than THR1 (206), then it will control switcher 213 and force the output from 207 to 0. Otherwise, the output from 207 will be used in both 208 and 209.

After the switcher 213, it is the field accumulator stage which will accumulate the result in the active video region. A few pixels on the border should be removed not only because of the requirement of this algorithm (the sandwich pattern detector need 1 pixel above and 1 pixel below, so it can only start from line 2 and end at line N−1 for a video with N vertical lines) but also we want to ignore some noise usually existing on the border area.

THR1 and THR2 are used to filter out noise or other distortion in video.

208 is a Neighbourhood weighting local accumulator. In a user defined window, for example, 3 lines vertically and 7 pixels horizontally, the output equals to:

Output=input<<N where N is number of valid Sandwich patterns in this 3×7 window. Binary left shift of the sandwich pattern amplitude will amplify the amplitude. The Neighbourhood weighting can provide high gain for feathering with bigger area.

The output from 208 will be accumulated for the whole field. Output of 210 is sandwich pattern accumulated amplitude (SPAA).

209 is a simple counter which counts the number of Sandwich patterns in a field. This number contains the information of the size of Sandwich pattern area.

FIG. 3 is the pixel selection chart for Sandwich pattern detector in FIG. 2 (201 and 202). The X axis is the time axis, from left to right are pixel in Previous-2 field, Previous-1 field, Previous field and Current field. The vertical axis is the physical position of each pixel in vertical direction from top to bottom. Since the input is an interlaced video, the physical vertical position of adjacent fields is shifted by half line in adjacent fields. For example, pixel B is at the middle (½ line) between pixel A and C.

In Current field, when we look at pixel C, we select two vertical adjacent pixels A and E as reference. A is one line above C and E is one line below C.

We also choose 2 pixels from previous field: B and D. The coordination of pixel B and D depend on the field polarity of previous field. If previous field is ODD (that means the current field is EVEN), if pixel A coordination is (x,y) where x is the horizontal coordination and y is the vertical coordination, then the coordination of pixel B is (x,y) and pixel D is (x,y+1). If previous field is EVEN, then the coordination of pixel B, D are selected as (x,y−1) and (x,y).

One pixel from Previous-2 field: F is also selected to compare with C so as to generate the frame motion.

The 5 pixels: ABCDE are divided as two groups: Group 1 is ABCD and Group 2 is BCDE. These two groups will be used as the input to Sandwich pattern detector in FIG. 2 (201 and 202).

FIG. 4 is a moving diagonal bar from left to right. The solid lines show the bar in previous field and dash lines show the bar in current field. Assuming the bar has higher luminance level than the background. For example, a white bar moving on a dark background.

Because the input is interlaced video, the vertical position of these two fields are vertically shifted by ½ line. For example, previous field exists only on ODD line and current field exists only on EVEN line, or vice versa.

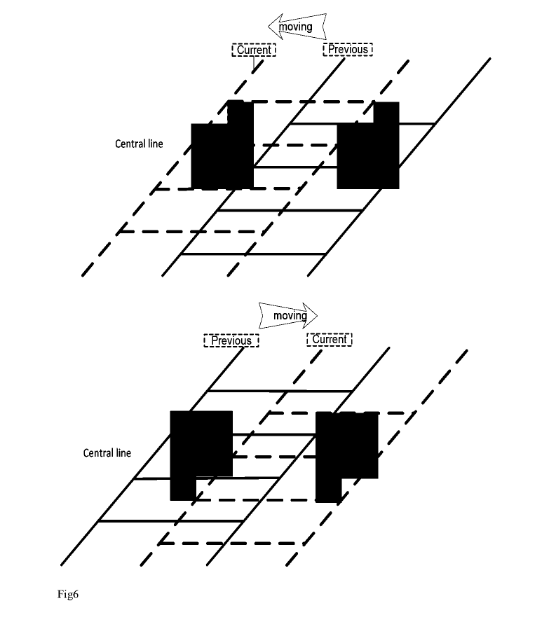

FIG. 5 is the Sandwich pattern detection result. Different patterns show the result respectively from group 1 and group 2. In this graph, C is the centre line which can be found in FIG. 3. In this example, for group 1 area, if we denote 1 as bright pixel and 0 as dark pixel, it has the pattern 0101 which satisfy x10x case in the Sandwich pattern detector. In this case, A=0, B=1, C=0 and D=1.

For group 2 area, we can find pattern 1010 which satisfy x01x case in the Sandwich pattern detector. In this case, B=1, C=0, D=1 and E=0.

On both right and left edge of the moving bar, we can find feathering and the Sandwich pattern can be detected.

The final total Sandwich area is the sum of both group 1 and group 2.

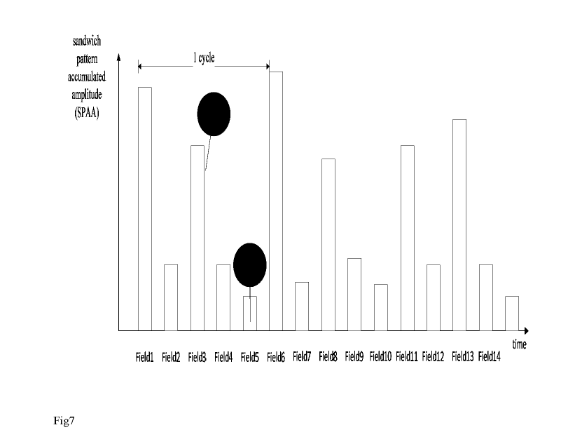

FIG. 6 shows the moving bar in different moving directions. We can find the Sandwich pattern detector output the same area no matter which direction the object moves. i.e. the Sandwich pattern detector is not sensitive to horizontal moving directions.

This Sandwich pattern detector always use 5 lines in two adjacent fields (3 lines in current field and 2 lines from previous field) so it is insensitive to current field polarity. This characteristic is important since the interlaced input is always changing the polarity continuously: ODD, EVEN, ODD, EVEN . . . . This Sandwich pattern detector can output the same result independent of the field polarity. If the Sandwich pattern detector changes according to field polarity even for a moving object with constant speed, it may output a high-low-high-low pattern and enter the 2:2 mode by mistake.

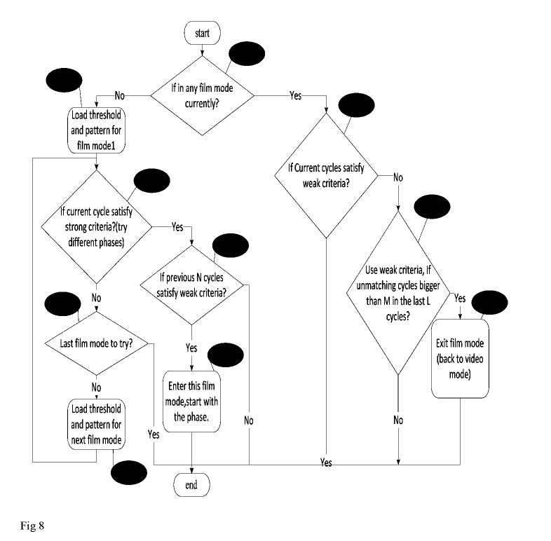

FIG. 7 is a typical SPAA for a 3:2 film mode. For 3:2 film mode, the pattern is 10100 where “1” means relatively high and “0” means relatively low. For such 3:2 pattern, 5 fields contain a matching “10100” or “10010” or “01010” pattern is defined as one cycle. The last phase of a cycle must be a “Low” phase so for 3:2 pattern, there are three cases for 1 cycle as listed above.

Different film pattern has different cycle length. For example, a 2:2 pattern has a “10” pattern and the cycle length is 2. For 22 cadence, there is only one possible phase: “10”.

FIG. 8 is the logic to determine film mode and phase. This flow chart can be used to output film mode/phase for both deinterlacer and temporal interpolator but the parameters are different.

For deinterlacer, we actually don't need to distinguish between some patterns, for example, 4:4 pattern and 2:2 pattern can both be treated as 2:2. So the film mode table can be simplified compare with the mode table for temporal interpolator.

There are two criteria used in FIG. 8.
The strong criteria
   This is the criteria where the input show strong film pattern. To enter a film mode, only can happen in the “low” phase of a cycle which satisfy the strong criteria.
   The strong criteria is defined as:
   High>thr1 AND Low<thr2; absolute high and low
   Or
   High/Low>thr3 AND Low<thr4; show high/low pattern relatively. Usually thr4 is higher than thr2.
   Or
   (Sandwich pattern number High)/(Sandwich pattern number Low)>thr5; the Sandwich pattern number in High phase is much bigger than the number in Low phase.
The weak criteria
   This is the criteria that a film mode can stay inside when it is satisfied. In the weak criteria, there is no requirement for the “High” phase since the input could be a static image and the “High” phase will be low in this case.
   The weak criteria is defined as:
   Low<thr6; absolute low in Low phase
   Or
   High/Low>thr7 AND Low<thr8; Low phase is relatively lower.
   Or
   (Sandwich pattern number High)/(Sandwich pattern number Low)>thr9 ; the Sandwich pattern number in High phase is much bigger than the number in Low phase.

In FIG. 8, 801 is to check if it is in film mode or not. For the film mode arbitrator, we always start from video mode after initialization.

To enter a film mode, we need:

N×Weak+1×Strong

Which means N cycles of pattern satisfies the weak criteria and the current cycle satisfies the strong criteria.

Film patterns are checked one by one. If all film patterns are tried but none of them satisfy the condition above, we will keep in video mode.

The pattern table should be carefully arranged since the pattern listed in earlier will be checked first hence has higher priority to enter. i.e. longer cadence which is partically overlapping with a shorter cadence should be checked earlier. For example, we need to put 4:4 pattern in front of 2:2 pattern. The 4:4 pattern has a High-Low pattern of: ‘1000’ and the 2:2 pattern has a High-Low pattern of: ‘10’. It is easy to find that 4:4 pattern will also satisfy the weak criteria of 2:2 pattern. So 4:4 pattern should be checked before 2:2 is tried. Otherwise, 4:4 pattern will be overwritten by 2:2 pattern.

To quick a film mode, we need:

NOT(M×Weak) in the last L cycles.

Which means M cycles (or more than M cycles) NOT satisfy weak criteria in the last L cycles. If the film mode output is for deinterlacer, M is always 1 to ensure a quick quit from film mode to avoid any feathering artefact shown on the screen.

If the film mode output is for temporal interpolation, M can be a small number which give some tolerance for short bad edition glitch in the video. This tolerance usually gives overall stability to the output video compare with switching between video and film back and forth.

I claim:

1. A sandwich pattern amplitude and number detector between two adjacent fields, the detector comprising:
Generating a sandwich pattern detection value between current field and previous field,
Adding the sandwich pattern detection value from two group of 4 pixels,
Comparing the sum of sandwich pattern of these two groups with a threshold and generate the final sandwich pattern value for current pixel,
Use the difference between current pixel and corresponding pixel at same location in previous-1 field to generate a frame motion value,
The frame motion value is compared with a threshold to generate a control signal which is 1 when the frame motion value is bigger than this threshold,
The control signal is used to switch between final sandwich pattern value for current pixel and 0 for the sandwich pattern amplitude field accumulator and counter,
The Neighbourhood weighting method is to boost the amplitude of sandwich pattern for the sandwich pattern amplitude accumulator.

2. The method as recited in claim 1, the two group of 4 pixel sandwich pattern detector which is insensitive to field polarity and horizontal movement direction are selected as 2 in current field and 2 in previous field in 4 contiguous lines on the final merged progressive frame.

3. The method as recited in claim 1, wherein the sandwich pattern detector the 4 pixels are compared to each other and valid sandwich pattern is noted as x01x or x10x where 1 means higher than 2 adjacent pixels and 0 means lower than 2 adjacent pixels.

4. The method as recited in claim 1, wherein the neighbourhood pixel weighting block, the sandwich pattern amplitude is left binary shifted by the number N where N is the number of valid sandwich patterns in a local window.

5. A unified film mode and phase determination method for both deinterlacer and temporal interpolator based on sandwich pattern accumulated amplitude (SPAA) and number between two adjacent fields, the method comprising:
Distinguishing between “in film mode” case and “in video mode” case and treat them differently,
Support multiple film cadences in an order where pattern with longer cycles are determined first,
A strong criteria is checked as high/low pattern that satisfy one film mode strongly where high/low is generated by comparing the SPAA with thresholds or combine the relative amplitude of high/low and another threshold,
A weak criteria is checked as high/low pattern that satisfy one film mode weakly where low phase is generated by comparing the SPAA with thresholds or combine the relative amplitude of high/low and another threshold,
To enter a film mode requires N×weak+1×strong which means N contiguous cycles satisfy the weak criteria and the current cycle satisfy the strong criteria,
To quit a film mode if there is more than M cycles not satisfy the weak criteria in the last L cycles.
